(19) United States
(12) Patent Application Publication
(10) Pub. No.: US 2015/0316282 A1
(43) Pub. Date: Nov. 5, 2015

(54) STRATEGY FOR EFFICIENTLY UTILIZING A HEAT-PUMP BASED HVAC SYSTEM WITH AN AUXILIARY HEATING SYSTEM

(71) Applicant: Board of Regents, The University of Texas System, Austin, TX (US)

(72) Inventors: Peter Stone, Austin, TX (US); Daniel Urieli, Austin, TX (US)

(21) Appl. No.: 14/703,995

(22) Filed: May 5, 2015

Related U.S. Application Data
(60) Provisional application No. 61/988,382, filed on May 5, 2014.

(51) Int. Cl. F24F 11/00; G05B 13/04

(52) U.S. Cl. CPC F24F 11/006; F24F 11/0012; F24F 11/0086; G05B 13/048; F24F 2011/0013; F24F 11/0034; F24F 2011/0047; F24F 2011/0058; F24F 2011/0063; F24F 2011/0065; F24F 2011/0071; F24F 2011/0075

(57) ABSTRACT

A method, system and computer program product for efficiently utilizing a heat-pump based HVAC system with an auxiliary heating system. Possible actions (e.g., cooling, off, heat-pump heating and auxiliary heating) are selected over a period of time (e.g., three days). The effects of selecting actions are recorded in terms of a data set of tuples. A regression is fitted to model a transition function separately for each of the possible actions using the data set of tuples. A model is selected to fit a regression using regression features (e.g., historic indoor temperatures). An action (e.g., off) to take is determined using a lookahead planning approach during a don't care period (period of time occupants do not care about the inside temperature) for every time-step within the don't care period until an end of the don't care period, where the effects of the actions continue to be recorded.

### CROSS REFERENCE TO RELATED APPLICATIONS

This application is related to the following commonly owned co-pending U.S. patent application:

Provisional Application Ser. No. 61/988,382, “A Learning Agent for HVAC Thermostat Control,” filed May 5, 2014, and claims the benefit of its earlier filing date under 35 U.S.C. §119(e).

### GOVERNMENT INTERESTS

This invention was made with government support under Grant Nos. IIS-0917122 awarded by National Science Foundation, 61-2075UT awarded by National Science Foundation, CNS-1305287 awarded by National Science Foundation, CNS-1330072 awarded by National Science Foundation, 21C184-01 awarded by the Office of Naval Research; N000014-09-1-0658 awarded by the Office of Naval Research; FA8750-14-1-0070 awarded by U.S. Air Force Research Laboratory and DTFH61-07-H-00030 awarded by the Federal Highway Administration. The U.S. government has certain rights in the invention.

### TECHNICAL FIELD

The present invention relates generally to monitoring and controlling of heating, cooling and air conditioning (HVAC) systems, and more particularly to implementing a strategy for efficiently utilizing a heat-pump based HVAC system with an auxiliary heating system.

### BACKGROUND

According the United States Department Of Energy, 40% of the energy consumed in the United States is consumed by residential (22%) and commercial (18%) buildings. Furthermore, heating, ventilation and air conditioning (HVAC) systems are responsible for more than 50% of the energy consumed by buildings. With the efforts of moving to sustainable energy consumption, heat-pump based HVAC systems have gained popularity due to their high efficiency and due to the fact that they are powered by electricity as opposed to being powered by gas or oil.

One drawback of heat-pump based HVAC systems is that their efficiency sharply decreases when the outdoor temperature is around or below freezing. As a result, heat-pump based HVAC systems are backed up by an auxiliary heating system that is effective in cold weather, but that consumes about twice as much energy.

A popular way of saving energy in HVAC systems is “setting back the thermostat” referring to relaxing the heating/cooling requirements when the occupants are not occupying the home/office/building. Such practice though may increase the energy consumption in a heat-pump based HVAC system since recovering the temperature back frequently results in excessive use of an energy expensive, electric-resistance auxiliary heater.

As a result, there is not currently a means for minimizing energy consumption by efficiently utilizing a heat-pump based HVAC system while satisfying the comfort requirements of the occupants.

### BRIEF SUMMARY

In one embodiment of the present invention, a method for efficiently utilizing an HVAC system comprises selecting each of a plurality of possible actions over a first period of time. The method further comprises recording effects of selecting actions in terms of a data set of tuples during the first period of time. The method additionally comprises selecting a model to fit a regression using regression features during a second period of time, where the regression features comprise a current indoor temperature, a current outdoor temperature and a plurality of historic indoor temperatures. Furthermore, the method comprises fitting the regression to model a transition function for each of the plurality of possible actions using the data set of tuples during the second period of time. Additionally, the method comprises determining, by a processor, an action to take using a lookahead planning approach of the selected model during the second period of time for every time-step within each sub-period of the second period of time until an end of the sub-period of the second period of time, where the time-step corresponds to a fixed segment of time within the second period of time, and where the action corresponds to implementing one of the plurality of possible actions. In addition, the method comprises recording effects of selecting actions in terms of the data set of tuples during the second period of time.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates a heating, ventilating, and air conditioning (HVAC) system being implemented in a building, such as a house, in accordance with an embodiment of the present invention;

FIG. 2 illustrates an embodiment of the HVAC system in accordance with an embodiment of the present invention;

FIG. 3 illustrates a hardware configuration of a control unit which is representative of a hardware environment for practicing the present invention;

FIG. 4 illustrates the “heating slope” and the “auxiliary slope” in accordance with an embodiment of the present invention;

FIG. 5 is a flowchart of a method for efficiently utilizing a heat-pump based HVAC system in an exploratory period in accordance with an embodiment of the present invention;

FIG. 6 is a flowchart of a method for efficiently utilizing a heat-pump based HVAC system after the exploratory period in accordance with an embodiment of the present invention;

FIGS. 7A and 7B show the cross-validation error versus the number of features in accordance with an embodiment of the present invention;

FIG. 8 is a histogram of the noise added to all weather forecasts synthetically generated using this noise over a period of one simulated year, where forecasts predict 6-17 hours into the future in accordance with an embodiment of the present invention;

FIGS. 9A-9D illustrate the energy savings using the agent of the present invention in 21 different house sizes using typical weather conditions recorded in New York City, Boston and Chicago when including and excluding the three exploration days in accordance with an embodiment of the present invention;

FIG. 10 is a histogram showing how the agent of the present invention minimizes violations of the temperature comfort requirements (69-75° F., vertical lines) in accordance with an embodiment of the present invention;

FIGS. 11A-11D illustrate how the agent of the present invention controls the temperature in mild and extreme winter/summer days in accordance with an embodiment of the present invention; and

FIG. 12 is a table that shows an ablation analysis that tests the contribution of each of the agent's main components to its overall performance in accordance with an embodiment of the present invention.

### DETAILED DESCRIPTION

While the following discusses the present invention in connection with a strategy for efficiently utilizing a heating, ventilating, and air conditioning (HVAC) system with an auxiliary heating system, the principles of the present invention may be applied to an HVAC system without an auxiliary heating system. A person of ordinary skill in the art would be capable of applying the principles of the present invention to such implementations. Further, embodiments applying the principles of the present invention to such implementations would fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

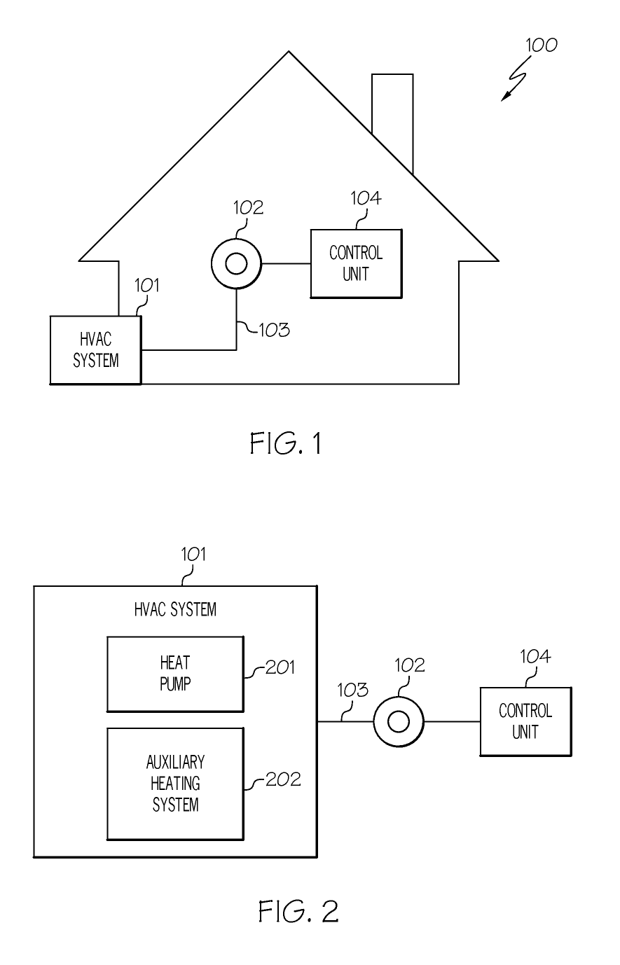

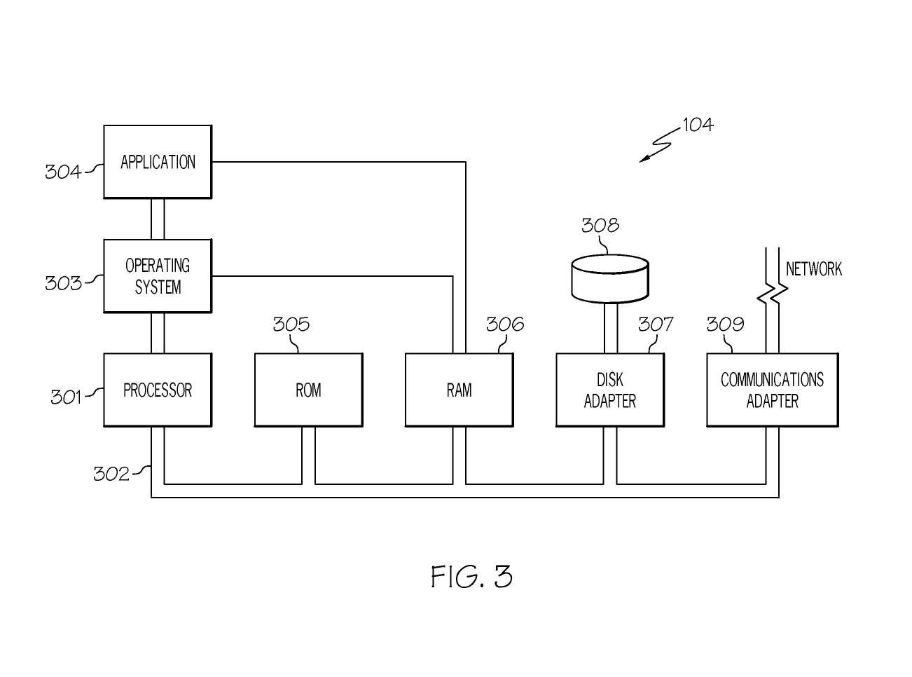

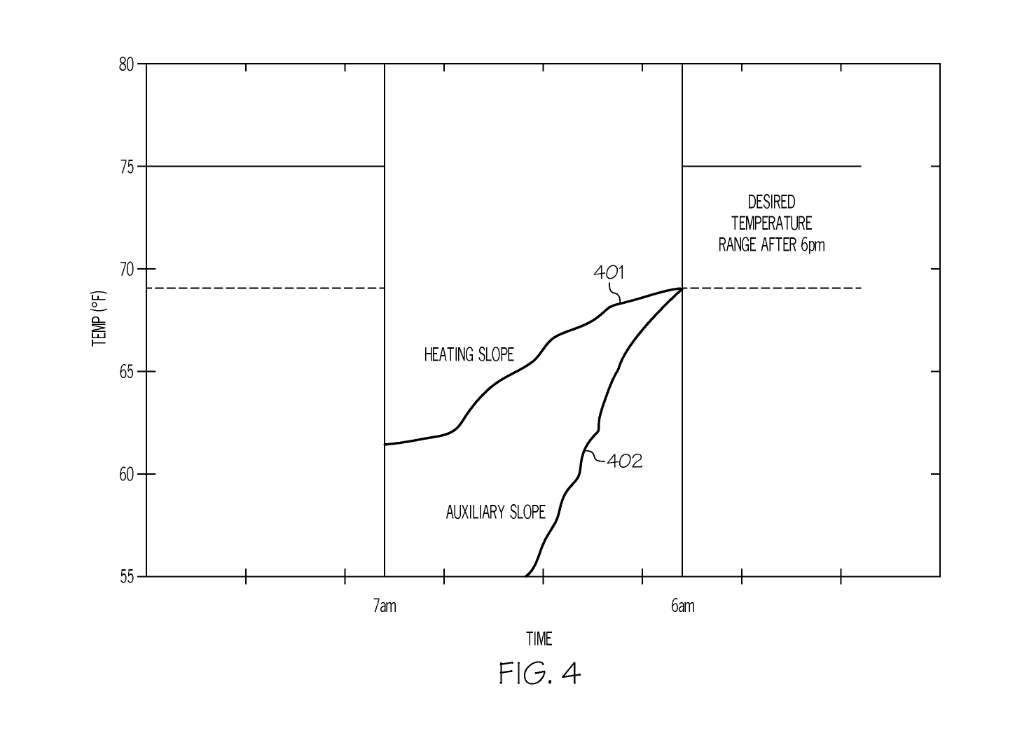

Referring now to the Figures in detail, FIG. 1 illustrates a heating, ventilating, and air conditioning (HVAC) system being implemented in a building, such as a house, in accordance with an embodiment of the present invention. As illustrated in FIG. 1, house 100 includes an HVAC system 101 connected to a thermostat 102 via a set of wires 103 extending from HVAC system 101. In one embodiment, thermostat 102 is connected to a control unit 104 configured to control an inside temperature of house 100 via thermostat 102 by switching heating or cooling devices on or off, or regulating the flow of a heat transfer fluid as needed, to maintain a desired temperature inside house 100. While the foregoing discusses thermostat 102 controlling the inside temperature of house 100 by switching heating or cooling devices on or off or regulating the flow of a heat transfer fluid as needed, thermostat 102 may control the inside temperature of house 100 using other means. The principles of the present invention are to include any means for thermostat 102 controlling the inside temperature of house 100. A more detailed description of control unit 104 is provided below in connection with FIG. 3. In one embodiment, thermostat 102 may be embodied within control unit 104. While FIG. 1 illustrates HVAC system 101 being implemented in a residential building, the principles of the present invention may be applied to any heat-pump HVAC system, whether in a residential, office or commercial setting. A more detailed description of HVAC system 101 is provided below in connection with FIG. 2.

FIG. 2 illustrates an embodiment of HVAC system 101 (FIG. 1) in accordance with an embodiment of the present invention. As illustrated in FIG. 2, HVAC system 101 includes a heat pump 201 which provides heat energy from a source of heat to a destination called a “heat sink.” Heat pump 201 is designed to move thermal energy opposite to the direction of spontaneous heat flow by absorbing heat from a cold space and releasing it to a warmer one. Heat pump 201 is further configured to provide space cooling in a similar fashion. Heat pump 201 is generally more efficient in comparison to comparable systems since it moves energy rather than converting gas or oil to energy. As discussed in the Background section, one drawback with utilizing a heat pump 201 is that their efficiently sharply decreases when the outdoor temperature is around or below freezing. As a result, heat pump 201 is backed up with an auxiliary heating system 202 (e.g., resistive heat coil) that is effective in cold weather though may consume twice as much energy. As discussed below, the principles of the present invention provide a means for efficiently utilizing both heat pump 201 and auxiliary heating system 202 so as to provide greater energy savings in comparison to previous techniques to save energy using a heat-pump based HVAC system.

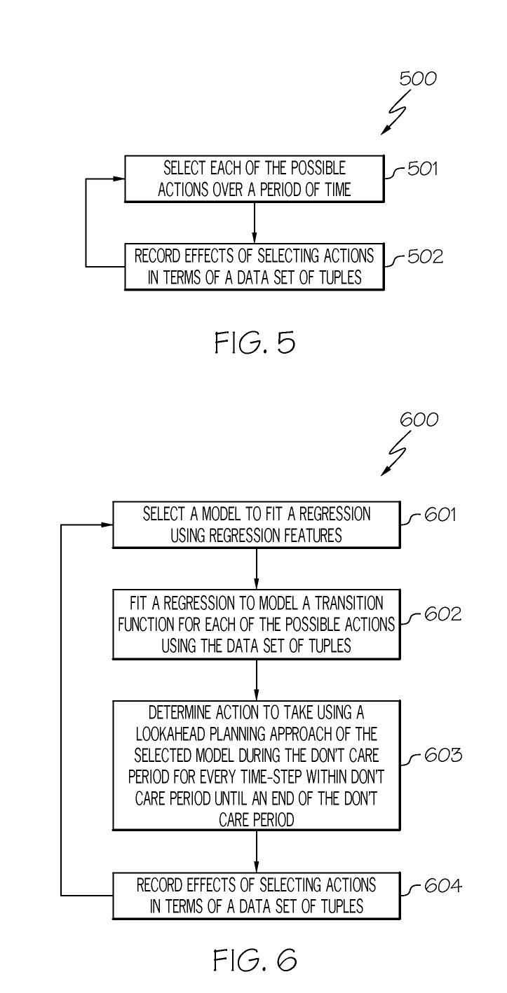

Referring now to FIG. 3, FIG. 3 illustrates a hardware configuration of control unit 104 (FIGS. 1 and 2) which is representative of a hardware environment for practicing the present invention. Control unit 104 has a processor 301 coupled to various other components by system bus 302. An operating system 303 runs on processor 301 and provides control and coordinates the functions of the various components of FIG. 3. An application 304 in accordance with the principles of the present invention runs in conjunction with operating system 303 and provides calls to operating system 303 where the calls implement the various functions or services to be performed by application 304. Application 304 may include, for example, a program for efficiently utilizing the heat-pump based HVAC system 101 (FIGS. 1 and 2) so as to provide greater energy savings as discussed further below in connection with FIGS. 4-6, 7A-7B, 8, 9A-9D, 10, 11A-11D and 12.

Referring again to FIG. 3, read-only memory (“ROM”) 305 is coupled to system bus 302 and includes a basic input/output system (“BIOS”) that controls certain basic functions of control unit 104. Random access memory (“RAM”) 306 and disk adapter 307 are also coupled to system bus 302. It should be noted that software components including operating system 303 and application 304 may be loaded into RAM 306, which may be control unit's 104 main memory for execution. Disk adapter 307 may be an integrated drive electronics (“IDE”) adapter that communicates with a disk unit 308, e.g., disk drive. It is noted that the program for efficiently utilizing the heat-pump based HVAC system 101 (FIGS. 1 and 2) so as to provide greater energy savings, as discussed further below in connection with FIGS. 4-6, 7A-7B, 8, 9A-9D, 10, 11A-11D and 12, may reside in disk unit 308 or in application 304.

In one embodiment, control unit 104 may further include a communications adapter 309 coupled to bus 302. Communications adapter 309 interconnects bus 302 with an outside network thereby enabling control unit 104 to obtain weather forecasts as well as communicate with thermostat 102 (FIG. 1).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated in the Background section, with the efforts of moving to sustainable energy consumption, heat-pump based HVAC systems have gained popularity due to their high efficiency and due to the fact that they are powered by electricity as opposed to being powered by gas or oil. One drawback of heat-pump based HVAC systems is that their efficiency sharply decreases when the outdoor temperature is around or below freezing. As a result, heat-pump based HVAC systems are backed up by an auxiliary heating system that is effective in cold weather, but that consumes about twice as much energy. A popular way of saving energy in HVAC systems is “setting back the thermostat” referring to relaxing the heating/cooling requirements when the occupants are not occupying the home/office/building. Such practice though may increase the energy consumption in a heat-pump based HVAC system since recovering the temperature back frequently results in excessive use of an energy expensive, electric-resistance auxiliary heater. As a result, there is not currently a means for minimizing energy consumption by efficiently utilizing a heat-pump based HVAC system while satisfying the comfort requirements of the occupants. Similarly, for cooling in the summer, setting back saves energy, but one needs to determine what times to cool in advance to avoid a comfort violation and minimize energy.

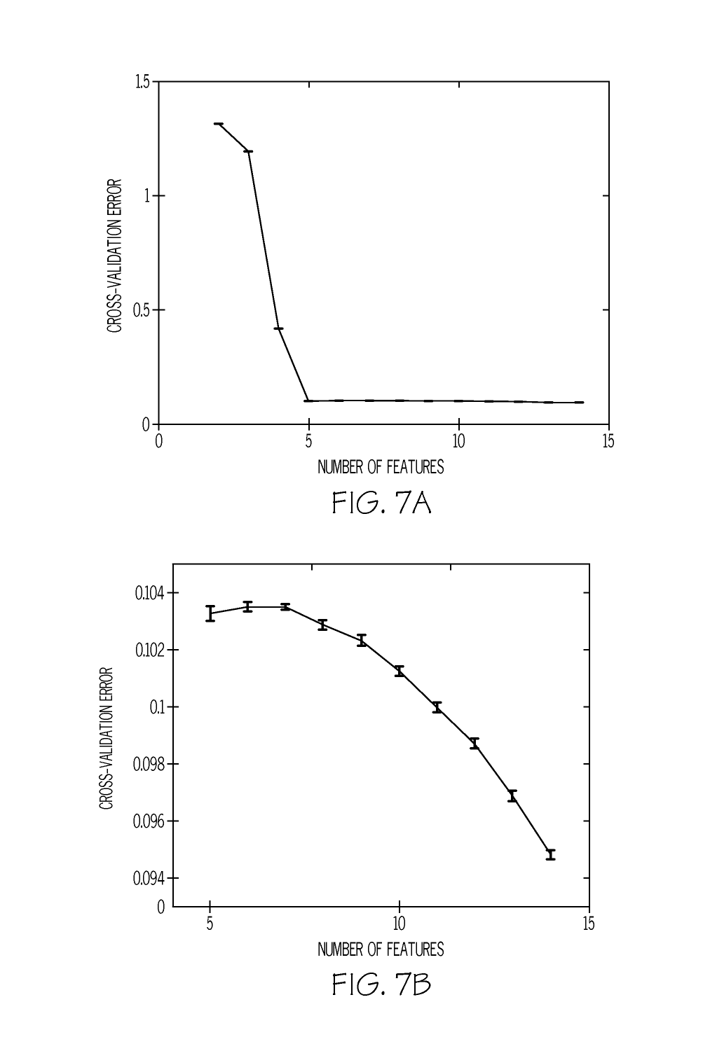

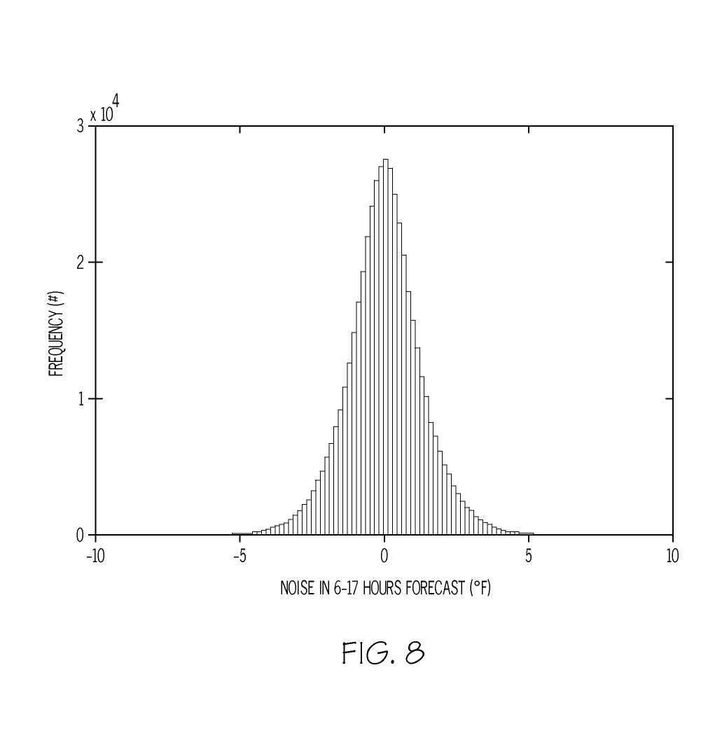

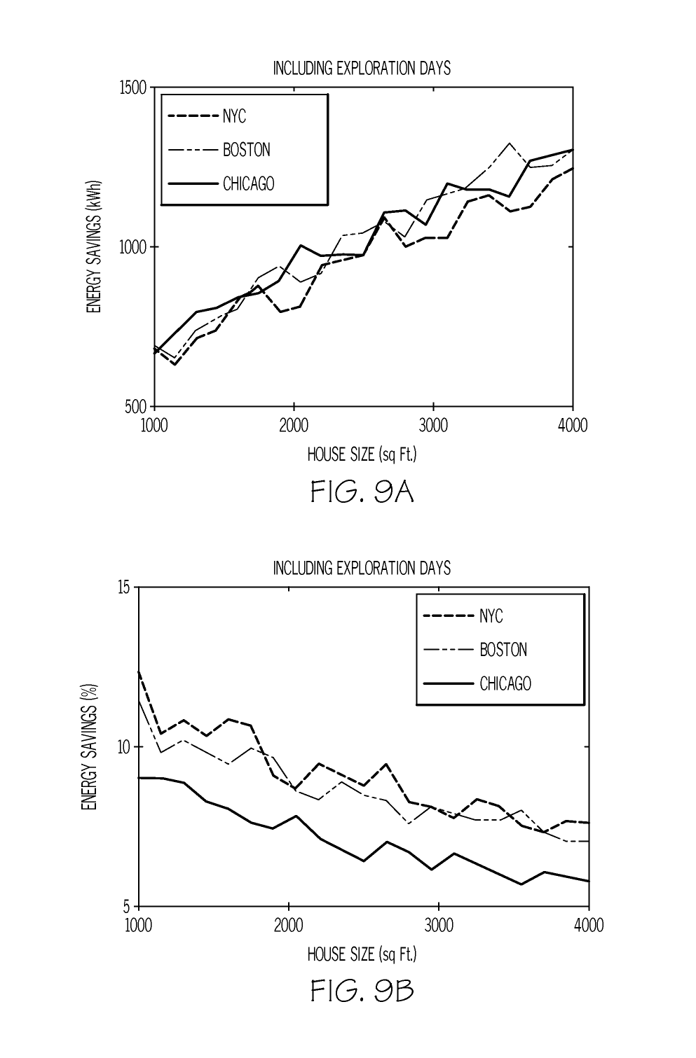

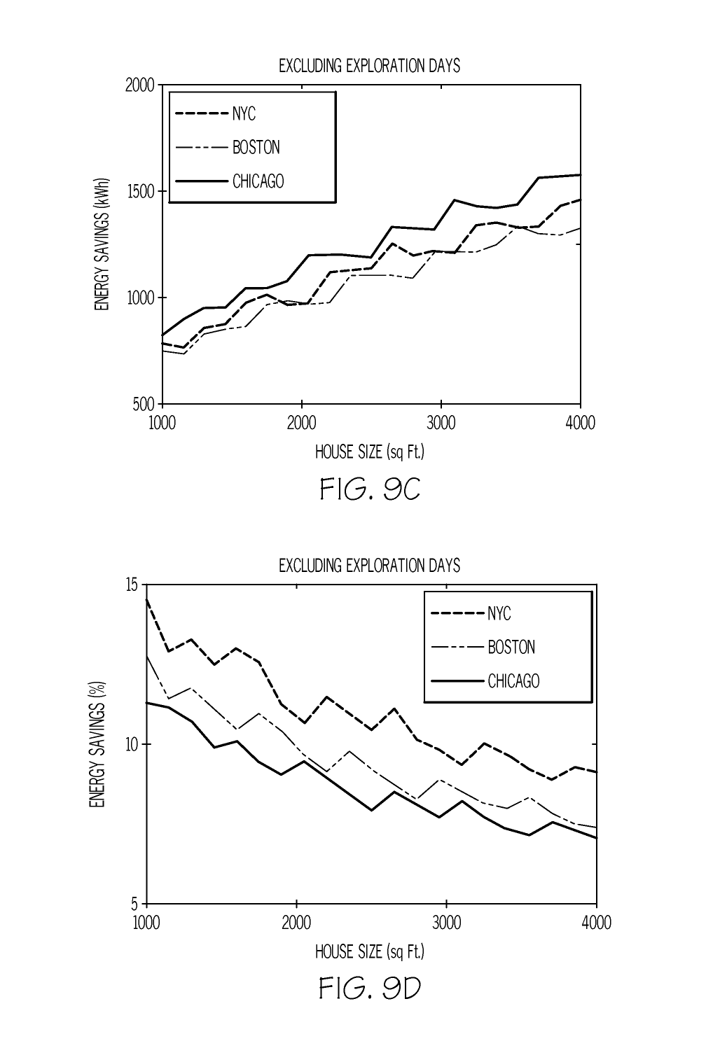

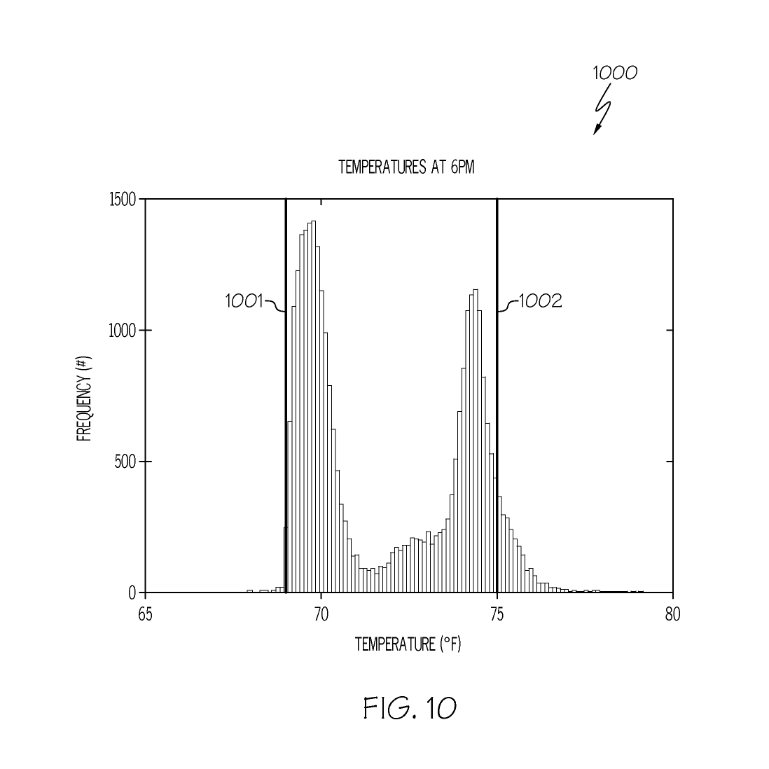

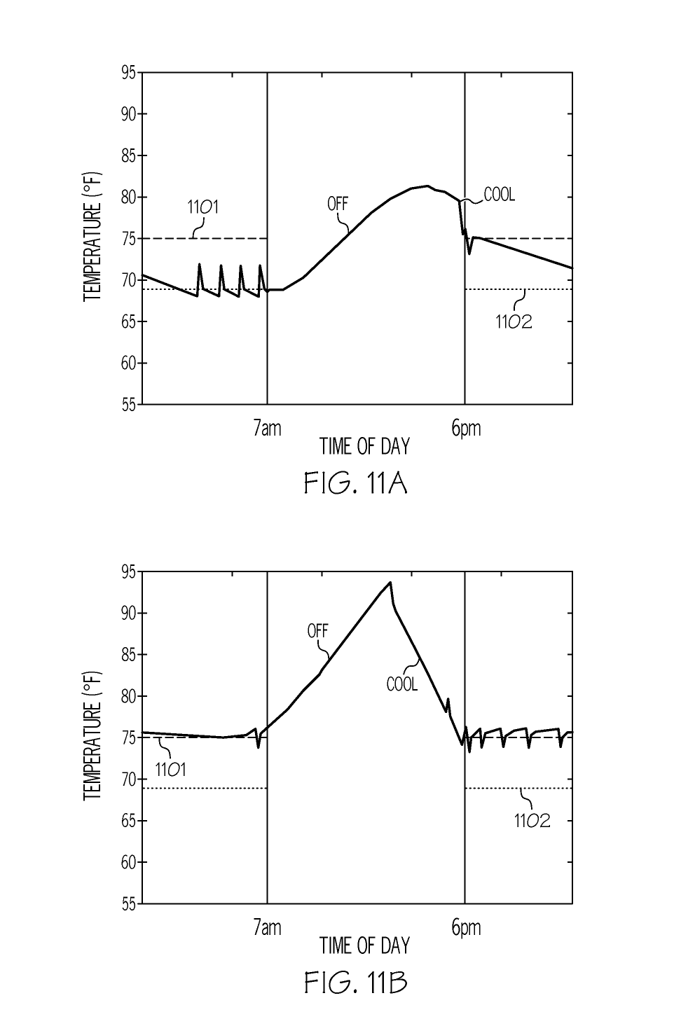

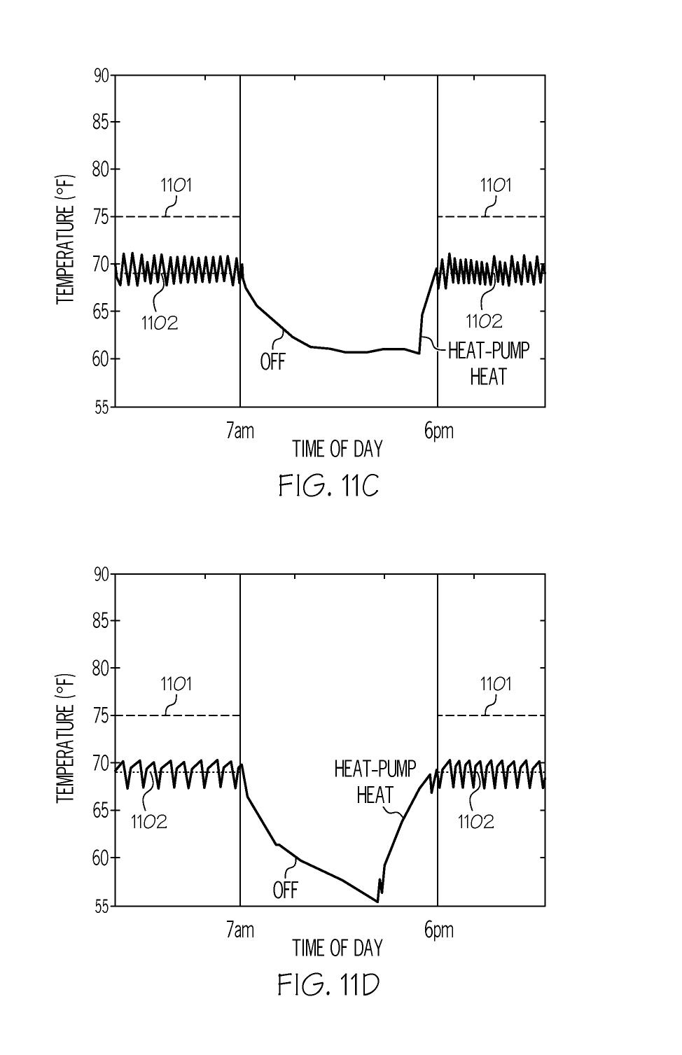

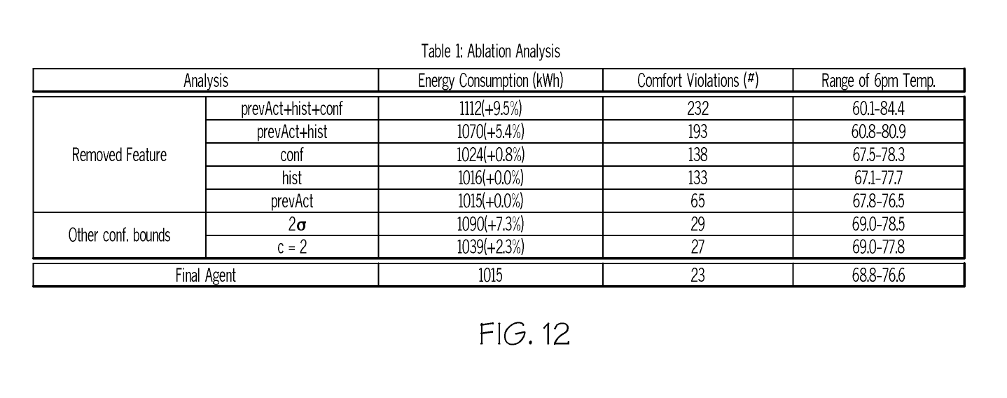

The principles of the present invention provide a means for efficiently utilizing energy consumption in a heat-pump based HVAC system while satisfying comfort requirements of the occupants as discussed below in connection with FIGS. 4-6, 7A-7B, 8, 9A-9D, 10, 11A-11D and 12. FIG. 4 illustrates the “heating slope” and the “auxiliary slope.” FIG. 5 is a flowchart of a method for efficiently utilizing a heat-pump based HVAC system in an exploratory period. FIG. 6 is a flowchart of a method for efficiently utilizing a heat-pump based HVAC system after the exploratory period. FIGS. 7A-7B show the cross-validation error versus the number of features. FIG. 8 is a histogram of the noise added to all weather forecasts synthetically generated using this noise over a period of one simulated year, where forecasts predict 6-17 hours into the future. FIGS. 9A-9D illustrate the energy savings using the agent of the present invention in 21 different house sizes using typical weather conditions recorded in New York City, Boston and Chicago when including and excluding the three exploration days. FIG. 10 is a histogram showing how the agent of the present invention minimizes violations of the temperature comfort requirements (69-75° F., vertical lines). FIGS. 11A-11D illustrate how the agent of the present invention controls the temperature in mild and extreme winter/summer days. FIG. 12 is a table that shows an ablation analysis that tests the contribution of each of the agent's main components to its overall performance.

As will be discussed further below, the principles of the present invention involve designing a complete reinforcement learning (RL) agent (program, such as application 304, of control unit 104 that efficiently utilizes heat-pump based HVAC system 101) that learns and applies a new adaptive control strategy for a heat-pump thermostat that (1) leads to roughly 7.0%-14.5% yearly energy savings in a realistic simulation of different house sizes and weather conditions, while (2) keeping the occupants' comfort level unchanged when compared to an existing strategy that is deployed in practice. Experiments are run using a complex, realistic simulator written for the United States Department of Energy. The strategy discussed herein simultaneously solves two related, but slightly different problems of heating in the winter and cooling in the summer. The agent of the present invention is realistically deployed in a simulated, unknown in advance house, and after three days of exploration (during which occupants could be traveling out of home) starts to save energy. The agent of the present invention makes decisions in real-time, and keeps learning and improving performance while acting, as it gathers more data.

In order to apply reinforcement learning (RL) to thermostat control, the problem was defined as a continuous state Markov Decision process (MDP). After randomly exploring the effects of its actions during the first three days, the agent uses a regression learning algorithm to fit a transition function that models the house in which the agent operates. Using information like weather forecast and history of past measurements results in a high-dimensional MDP state, and therefore it is impractical to plan, or compute a value function, over the whole state space. Therefore, the agent uses an efficient online lookahead policy, based on a constrained, specialized tree-search.

Prior to discussing the process for efficiently utilizing a heat-pump based HVAC system 101 (FIGS. 1 and 2), a brief discussion regarding the simulation environment used to test the thermostat strategy of the present invention is deemed appropriate.

Since real-world experiments would both be costly and take too much time, a complex, realistic HVAC simulation was relied upon to test the thermostat strategy of the present invention. Specifically, GridLAB-D, which is an open-source, smart-grid simulator that was developed for the United States Department of Energy, was used. Importantly for the purposes of the present invention, it has a residential building model, that includes heat gains and losses and the effects of thermal mass, as a function of weather (temperature and solar radiation), occupant behavior (thermostat settings and internal heat gains from appliances), and heating/cooling system efficiencies. It models parallel heat flow paths through the envelope of the building (walls, windows, doors, ceilings, floors, and infiltration air flows) and considers the mass of the air in the interior volume of the house. It uses meteorological data collected in hundreds of cities across the U.S. by the National Renewable Energy Laboratory, recorded in a standard TMY2 (Typical Meteorological Year) file format.

The simulation of the present invention uses a heat-pump based HVAC system. At its peak performance, a heat-pump can output heat energy that is 4 times higher than the energy it consumes. However, when outdoor temperatures are near or below freezing, its efficiency sharply decreases; therefore, it is backed up by an auxiliary heater, which is represented by a resistive heat coil in the simulation. On one hand, the auxiliary heater's efficiency is almost unaffected by the outdoor temperature, but on the other hand, it consumes about twice the energy consumed by the heat-pump heater. A resistive heat coil is a popular backup system, partly due to the expected entrance of renewable electricity sources to the market. A heat-pump is also used for cooling, and is not backed up by an auxiliary cooler.

From an artificial intelligence perspective, the focus of the present invention is on the decision making module of the house's HVAC system, namely the thermostat, such as thermostat 102 (FIG. 1). A widely deployed default thermostat strategy of “setting back the thermostat” (referring to relaxing the heating/cooling requirements when the occupants are not occupying the home/office/building) is simple and intuitive, but from the perspective of energy consumption, it has some drawbacks as discussed further below.

In the setup of the present invention, a single-family residential home is simulated, and the occupants are assumed to be at home between 6 pm and 7 am of the next day, and that the house is empty between 7 am and 6 pm (referred to herein as the “don't care period”). Furthermore, the don't care period may specify a range of inside temperatures, such as not being greater than 100° F. or less than 40° F. during the don't care period. In the embodiment directed to an HVAC system being implemented in a commercial building, the don't care period is throughout the night. The goal is to minimize the total energy consumed by HVAC system 101, while (1) keeping a desired temperature range of 69-75° F. whenever the occupants are at home, and (2) being indifferent to the home temperature during the don't-care period.

Under this setup, a straightforward setback strategy would be to turn the system off during the don't-care period, and turn it back on once occupants are at home. However, such setback of a thermostat that uses such a strategy can in fact increase consumption by more than 7% comparing to just leaving it always on. The main reason for this is that at the end of the don't-care period, the temperature is often significantly out of range, in which case the strategy forces extended use of the energy-expensive auxiliary heating unit. More regular use of the heat pump throughout the don't-care period ends up consuming less energy, as happens when leaving the thermostat always on. An additional problem with such setback is that requirement (1) is frequently violated, since it might take up to several hours for the HVAC system to bring the temperature back to the desired range.

However, setting back the temperature is still desirable for saving energy, as long as it does not cause unnecessary use of auxiliary heating. This is due to the fact that setting back gets the indoor temperature closer to the outdoor temperature, which in turn slows the heat dissipation, so that less energy is needed to compensate for heat energy losses. Therefore, an ideal strategy would be able to predict whether it is possible to set back the thermostat for some time, then start heating enough in advance using the heat-pump whenever possible and auxiliary heating when unavoidable, so as to reach the desired temperature by the time the occupants are back, thus allowing the temperature setback to effectively save energy, while leaving the occupants' comfort unchanged. As discussed further herein, such a strategy is defined and tested.

FIG. 4 illustrates a challenge in designing such a strategy. FIG. 4 illustrates the heating slope and the auxiliary slope in accordance with an embodiment of the present invention. Referring to FIG. 4, for a given day, let the heating slope 401 be the (not necessarily straight) line consisting of all (x, y) points, such that if x is a time of day in the don't-care period and y is the indoor temperature at time x then turning on heat-pump 201 (FIG. 2) at time x would bring the indoor temperature back into the desired range, exactly at 6 pm. The auxiliary slope 402 is defined similarly for the auxiliary heater 202 (FIG. 2). Note that these slopes are only hypothetical, and cannot exactly be computed in advance, as doing so requires a complete knowledge of the world-states throughout the uncertain future. During a don't care period, as long as a temperature y at time x is above heating slope 401 (resp. auxiliary-slope), an agent can reach the desired temperature at 6 pm using only the heat-pump 201 (resp. auxiliary heater). A good strategy should handle the tradeoff of trying to setback the temperatures to as close as possible to the (unknown) heating slope 401, while keeping a safe distance above it, to avoid the need to use auxiliary heater 202 in the face of possible outdoor temperature drops. More generally, depending on the specific house properties and weather conditions, there exists some path through the time-temperature space (such as the one in FIG. 4) that would lead to minimal energy consumption.

The challenge is to design a control strategy that would be able to approximate this path for each house the agent of the present invention is deployed in, and for any weather conditions. Note that to this point, the focus has been on winter, which is more complicated than summer due to the two different heating actions. In fact, the strategy of the present invention works in the summer as well, where there is only one cooling action (so no need to avoid a more expensive action), but where there is still the challenge of setting back the thermostat to save energy, and start cooling in advance to bring the temperature back to range on time. In the experiments of the present invention, tests have been run throughout the year, thus testing both conditions simultaneously.

It has been assumed that the default thermostat strategy is used to keep the temperature in range whenever occupants are at home, in order to keep a similar comfort level across all tested strategies (so that only energy usage differs), and due to the lower potential for energy savings at these times. Therefore, changing the thermostat strategy during the don't-care period is only considered.

A discussion regarding utilizing such a process for controlling thermostat 102 (FIG. 1) to efficiently utilizing heat-pump based HVAC system 101 (FIGS. 1 and 2) is discussed below in connection with FIGS. 5 and 6.

FIG. 5 is a flowchart of a method 500 for efficiently utilizing a heat-pump based HVAC system in an exploratory period in accordance with an embodiment of the present invention. The exploratory period refers to a period of time (e.g., three days) to learn the house characteristics. FIG. 6 is a flowchart of a method 600 for efficiently utilizing a heat-pump based HVAC system after the exploratory period in accordance with an embodiment of the present invention.

Referring to FIG. 5, in conjunction with FIGS. 1-3, in step 501, control unit 104 selects each of the possible actions (e.g., cooling, off, heat-pump heating and auxiliary heating) over a period of time (e.g., exploratory period, such as three days). While the description herein discusses utilizing four possible actions, such as cooling, off, heat-pump heating and auxiliary heating, the principles of the present invention are not to be limited in scope to utilizing any specific number of actions.

In step 502, control unit 104 records the effects of selecting actions in terms of a data set of tuples.

Upon recording the effects of selecting actions in terms of a data set of tuples, control unit 104 continues to select each of the possible actions (e.g., cooling, off, heat-pump heating and auxiliary heating) over the exploratory period of time in step 501.

As will be discussed further below, during the initial period of time that the learning agent is deployed, such as three days, the effects of selecting each of the possible actions are recorded in terms of tuples of data. After this initial period of time, control unit 104 executes an energy saving set-back policy as discussed below in connection with FIG. 6. While doing so, control unit 104 continues to record the effects of its actions in the form of tuples of data.

Thermostat 102 works in the real-time cycle of sensing the world state, for instance the temperature and the time of day; running some computations; and acting by choosing one of four actions: cooling, off, heat-pump heating, or auxiliary heating. A strategy's goal is to minimize a cost function, which is the total energy it uses over some period, while satisfying a desired comfort level. Formally, this problem can be represented as a Markov Decision Process (MDP). An (episodic) MDP is a tuple (S, A, P, R, T), where S is the set of states; A is a set of actions; P:S×A×S→[0, 1] is a state transition probability function where P(s, a, s′) denotes the probability of transitioning to state s′ when taking action a from state s; R:S→R is a state-based reward function; and TεS is a set of terminal states, where entering one of which terminates an episode. The MDP of the present invention is defined as follows:
S: {Tᵢₙ, Tₒᵤₜ, Time, eₐ, prevAction, t₀, . . . , t₉, weatherForecast}. Here, Tᵢₙ and Tₒᵤₜ are the indoor and outdoor air temperatures, respectively; Time is the time of day; eₐ is the energy consumed by last action; prevAction is the previously taken action; t₀, . . . , t₉ is a history of the last 10 indoor temperatures, and weatherForecast is a noisy weather forecast from the current step until the end of an episode. It is noted that these state features are illustrative and that the principles of the present invention are not to be limited in scope to such disclosed features.
A: {cool, off, heat, aux}. Namely, there are four possible actions for cooling, off, (heat-pump) heating and auxiliary heating, respectively. It is noted that these actions are illustrative and that the principles of the present invention are not to be limited in scope to such disclosed actions.
P: a complex, initially unknown, transition model given by the GridLAB-D simulator, based on the house properties, and the environmental conditions.
R: −eₐ−c₆ₚₘ. Here, c₆ₚₘ=100,000 (example of a value used for a “reward”)×Δ²ₜₑₘₚ is a large quadratic cost applied when missing the temperature spec at 6 pm by Δₜₑₘₚ to help enforcing the comfort constraint. The energy consumption proportion is roughly 1:0:2:4 for cool:off:heat:aux respectively, but is specific to each house/weather condition and is unknown in advance. It is noted that the principles of the present invention are not be limited in scope to specific values used for a reward (e.g., 200,000 could be used). Neither are the principles of the present invention limited in scope to using the squaring of the change in temperature to computing R.
T: {sεS|s·time==23:59 pm}

A discussion regarding the choice of state representation is provided below. In the MDP of the present invention, an action is taken every 6 minutes, as the simulator models a realistic lockout of the system, such that every control action is applied for at least 6 minutes. In the context of MDPs, the goal of RL is to learn an optimal policy, when the model (namely P and/or R) is initially unknown. A policy is a mapping π: S→A from states to actions, and an optimal policy is defined as one that maximizes the long-term rewards, or equivalently minimizes the long-term costs, from every state.

When the agent is deployed in a new house, in order to perform robustly it needs to learn the characteristics of the specific house and heating system it controls, and adapt its control strategy to these characteristics. It does so by exploring and learning the effects of its actions in the house's environment for three simulated days. During this period, the agent selects each of the four possible actions and records their effects. While in practice it might be possible to use a more advanced exploration policy, for the purpose of the present invention, it is assumed that a one-time 3-day random exploration is still a realistic setup, for instance during a weekend where occupants are traveling. However, the present invention is not to be limited in scope to using this exploration method or period as other methods or periods could potentially be used. Action effects are recorded in the form of {s, a, s′} tuples where s is a state, a is an action taken from s, and s′ is the next state transitioned into after taking action a in s. Note that since eₐ is part of the state in the definition of the MDP, the reward can be computed exactly by the agent at every given state. One advantage of fully random exploration is a quick coverage of larger portions of the state space and of different action sequences, which facilitates faster learning. A disadvantage of it is increased energy consumption, but this is outbalanced by the energy savings starting the fourth day throughout the year.

Starting the end of the third day, the agent plans and executes an energy saving set-back policy as discussed below in connection with FIG. 6.

FIG. 6 is a flowchart of a method 600 for efficiently utilizing a heat-pump based HVAC system after the exploratory period in accordance with an embodiment of the present invention.

Referring to FIG. 6, in conjunction with FIGS. 1-5, in step 601, control unit 104 selects a model to fit a regression using regression features.

In step 602, control unit 104 fits a regression to model a transition function for each of the possible actions using the data set of tuples.

Prior to discussing steps 601 and 602 in detail, a brief description of the agent executing an energy saving set-back policy is deemed appropriate. While doing so, the agent keeps recording the effects of its actions, fitting a regression model to the accumulated action-effect tuples once at every user configured period (e.g., every hour, at midnight). Based on the most recently learned model, the agent keeps executing an efficient lookahead policy to choose the next action. The main routine for action selection, called at every time step with the current state observation, is summarized in Algorithm 1 shown below. As discussed further below, there are two main subroutines of this algorithm, namely the agent's model-learning algorithm (LearnHouseModel) (step 602), and the agent's planning and action selection algorithm (TreeSearch) (step 603).

Algorithm 1 [main routine] SelectAction(currentState)

| | |
|---|---|
| 1: | dataSet.add(prevState, prevAction, currentState) |
| 2: | t ← currentState.Time |
| 3: | if t ∈ firstThreeDays then |

| | |
|---|---|
| 4: | return randomSelect(cool, off, heat, aux) |

| | |
|---|---|
| 5: | else |

| | |
|---|---|
| 6: | if t = midnight then |

| | |
|---|---|
| 7: | model ← LearnHouseModel(dataSet) |

| | |
|---|---|
| 8: | if t ∈ don't-care period then |

| | |
|---|---|
| 9: | bestAction ← TreeSearch(model) |
| 10: | return bestAction |

| | |
|---|---|
| 11: | else |

| | |
|---|---|
| 12: | return thermostatAction( ) |

The agent learns the house characteristics in a routine named LearnHouseModel (step 602). LearnHouseModel fits regression models to the collected data-set of {s, a, s′} tuples, which are samples from the house's state transition function. The agent uses these tuples as labeled examples <s, a>→s′ for fitting a regression to model the transition function, separately for each of the four actions (a total of four regression runs). One part in learning the transition function is selecting what features to include as the regression's independent variables. In turn, this implies the features included in the state representation, used here as a main guideline:

Definition 1.

A state variable is the minimally dimensioned function of history that is necessary and sufficient to compute the decision function, the transition function, and the contribution (here the reward) function.

In what follows, the process by which the regression features is selected, and therefore the state, is described (step 601). Three features in the state that are used for computing the reward function are as follows: Tᵢₙ, eₐ, and Time. For computing the transition function, features that help predict Tᵢₙ and eₐ are needed (Time can be directly computed). For the ease of understanding and brevity, the process of selecting features for predicting Tᵢₙ are only described, but the process for selecting features for predicting eₐ is conceptually similar and uses a subset of the state-variables needed for predicting Tᵢₙ. For predicting Tᵢₙ at the next time-step, an obvious feature that is included, besides Tᵢₙ itself, is the outdoor temperature at the current time step, Tₒᵤₜ, as it directly affects the heat-pump operation, and is easily measurable, similarly to Tᵢₙ. A linear regression using only Tᵢₙ and Tₒᵤₜ for predicting Tᵢₙ is tested. Note that during regression runs a constant 1 is added as a “bias” (regression-only) feature, to enable affine regression. To test the prediction's accuracy, data was generated by simulating one year of actions and recording the resulting 87,600 {s, a, s′} tuples, one for each 6-minute time-step during one year. The prediction error was then calculated in a cross-validation test which repeatedly chooses 70% of the data as a training set and the rest 30% of the data as a validation set and averages the results of multiple runs. The cross-validation's error measure is the mean-squared prediction error over the validation-set, but the related and more intuitive error measure of the standard deviation of the prediction errors, measured in ° F. (Fahrenheit) is reported herein.

Using only Tᵢₙ and Tₒᵤₜ the prediction error is unacceptably high: a standard deviation of more than 1° F. for a 6 minutes time-step. This means that over 1 hour, the standard deviation of the prediction error is 10° F., which makes it hard to plan actions several hours in advance. A main source of prediction error is a hidden state of the house and the environment, for example, the temperatures of the house's walls and furniture, that serve as heat capacitors, and causes actions to have delayed effect. While a realistic thermostat generally cannot measure this hidden part of the state, it could use observable quantities that affect or correlate with the hidden part of the state. Specifically, the previous action taken by the thermostat and a history of 10 measured indoor-temperatures are added as features. Adding the previous action as a feature results in 4×4=16 combinations for the recent pair of actions, and for each such combination a separate regression is run, in a total of 16, rather than 4, regressions. It is noted that if there are n actions, then n² can be quite large. As a result, the “prev-action” feature may be omitted so that there will be just n regressions as opposed to n² regressions. The 10 historic temperatures are added directly as regression features. FIGS. 7A-7B show the cross-validation error versus the number of features in accordance with an embodiment of the present invention. In particular, FIGS. 7A-7B show the cross-validation error achieved by incrementally adding regression features, starting from the two features of Tᵢₙ and bias, then adding Tₒᵤₜ, adding the previous action, and then adding 10 historic temperatures one-by-one, from the most recent to the least recent, to a total of 14 features. Using all the features, the average standard deviation of the errors is less than 0.1° F. per 6-minute time-step, or less than 1° F. per hour. As each feature contributes to error reduction, the LearnHouseModel (step 602) is chosen to fit a linear regression using the above 14 features. Based on Definition 1, we include all these features (except the bias feature) in the state representation. Note that the cross-validation test was run on a typical 2,500 square foot home with weather conditions recorded at New-York City. As discussed below, the agent is tested under a range of house sizes and different weather conditions recorded in U.S. cities. It is noted that the principles of the present invention are not to be in scope to the use of all these features. Other features may be added and some of the features that were discussed above may be removed.

Adding features to the state representation helps in predicting Tᵢₙ as a part of the transition function. But, being part of the state, these state features now need to be predicted as a part of the transition function. All but one of the added features are just forward recordings of past measurements, and can be directly computed from <s, a> without the need to predict them. The only one that needs to be predicted is Tₒᵤₜ. However, Tₒᵤₜ is different than Tᵢₙ in that it is independent of the agent's actions and can be considered as an information state, a term that refers to the part of the state describing random processes external to the agent. The approach taken herein for predicting Tₒᵤₜ is using a weather forecast that is assumed to be given by an external source. For instance, the agent can connect to a weather forecast agency using the Internet infrastructure in a realistic deployment. As the weather forecast is needed for predicting Tₒᵤₜ which is already part of the state, based on Definition 1, the weather forecast is added to the state representation as a (multidimensional) state feature. As the weather forecast is given from an external source, it does not need to be predicted by itself from <s, a>, so no further features are needed in the state representation and the resulting state representation is the one defined above. For the purpose of simulation, a noisy weather forecast from the actual future weather data, given in the TMY2 file, is generated using the following rule. At a specific hour h, the forecast for i hours into the future, denoted as fₕ₊ᵢ is defined (recursively) as:

$${f}_{h + i} = \{ \begin{matrix}{T}_{out} ( h ) & if i = 0 \\ {f}_{h + i - 1} + N ( 0 , 0.5 ) & if i > 0\end{matrix}$$

where N(0, 0.5) is a normal random variable with μ=0 and σ=0.5. Note that the noisy forecast is computed at every time step until the end of the day, and therefore changes as time progresses. A histogram of the resulting forecast errors over one year, summarized together for forecast ranges of 6-17 hours into the future (these are the forecasts range needed during the don't-care period) is shown in FIG. 8 in accordance with an embodiment of the present invention.

Recall that the agent uses the default thermostat strategy to keep the temperature in range outside the don't-care period, whenever occupants are at home. During the don't-care period, the agent plans and selects actions using the nightly learned model, with the goal of executing an effective set-back strategy that both saves energy and minimizes violations of the temperature comfort requirements. In MDP terms, the agent's goal is finding a policy that maximizes the long-term reward. In general, once the approximate transition (and/or reward) functions are learned, the agent can use them to approximate the optimal policy using either one of the following three methods, or a combination of them: value-function approximation, policy function approximation, or lookahead methods.

The principles of the present invention utilize a lookahead method as discussed below.

In step 603, control unit 104 determines the action to take using a lookahead planning approach (e.g., tree-based lookahead approach) using the result of LearnHouseModel from step 602 during the don't care period for every time-step within the don't care period until an end of the don't care period.

Upon determining the action to take using the lookahead planning approach during the don't care period for every time-step within the don't care period until an end of the don't care period, control unit 104 continues to record the effects of its actions in the form of tuples of data in step 604.

Upon recording the effects of selecting actions in terms of a data set of tuples, control unit 104 continues to select a model to fit a regression using regression features in step 601. Alternatively, control unit 104 may select a model only a single time. In which case, upon recording the effects of selecting actions in terms of a data set of tuples, control unit 104 continues to fit a regression to model a transition function for each of the possible actions using the data set of tuples in step 602.

Due to the dimensionality of the state representation, it might be computationally intensive, or even impractical to plan or approximate a value function over the whole state space. Assuming the agent has limited on-site computational resources, it needs an efficient way to plan its actions. Therefore, the agent uses an efficient tree-search lookahead that is limited to a specific class of policies. A lookahead search starts at some point during the don't-care period, and ends at the end of an episode, such as at midnight for example. As a result, the agent makes plans for time-ranges of 6-17 hours, using actions of 6-minute length. As predicted values at time t are used to estimate values at time t+1, predictions that are further into the future accumulates uncertainty and become more noisy. Therefore, an approach similar to Model-Predictive Control is taken, where the agent runs a lookahead search at a given time-step, uses the results of the search to determine only the next action to take, then runs a new search at the next time-step, and so on.

Algorithm 2 (shown further below) implements this lookahead search, selecting the next action to be the first action of the most promising path. Specifically, it initializes a priority queue (step 1) and retrieves the current weather forecast (step 2). Next, it iterates over every time-step i starting the current time until the end of the don't-care period (step 5). The simulate( ) function (steps 7, 9, 12) uses the model and the weather forecast to simulate a specific set-back policy, which applies one action from the current time-step until time-step i, and another action from time-step i until the end of the don't-care period. For instance, step 7 simulates applying off and then heat. Simulation continues from 6 pm until the end of episode at midnight, at this point simulating the default thermostat actions. Each simulation outputs the total accumulated reward along the simulated path, and the first action taken in this path (steps 7, 9, 12) which are then inserted into the priority queue as a key-value pair, where the total reward is the key and the returned action is the value (steps 8, 10, 13). Note that the first action could be either of the two simulated actions as initially i=m. The first action of the path that resulted in the highest reward is then selected for execution (step 15). The intuition behind the algorithm is to maximize the set-back time while still returning the temperature back to range by 6 pm, through an efficient search within a policy class that does exactly that. The reason step 9 is added, in which heat is simulated and then aux, is to account for cold days in which the heat-pump is not able to bring the temperature to the desired range. It is noted that the principles of the present invention are not to be limited in scope to the sequence of actions discussed above and may simulate other sequence of actions.

Algorithm 2 TreeSearch(model)

| | |
|---|---|
| 1: | Q ← priorityQueue( ) |
| 2: | f ← currentWeatherForecast( ) |
| 3: | m ← getTimeOfDayInMinutes(now) |
| 4: | end ← getTimeOfDayInMinutes(6pm) |
| 5: | for i ← m, m + 6, . . . , end do |

| | |
|---|---|
| 6: | if heatingNeeded then |

| | |
|---|---|
| 7: | [reward, action] = simulate(off, i, heat, f, model) |
| 8: | Q.add(reward, action) |
| 9: | [reward, action] = simulate(heat, i, aux, f, model) |
| 10: | Q.add(reward, action) |

| | |
|---|---|
| 11: | else if coolingNeeded then |

| | |
|---|---|
| 12: | [reward, action] = simulate(off, i, cool, f, model) |
| 13: | Q.add(reward, action) |

| | |
|---|---|
| 14: | [bestReward, bestAction] = Q.top( ) |
| 15: | Return bestAction |

An important part of the simulate( ) function is handling the uncertainty in the long-term predictions of Tᵢₙ. In general, regression models predict the expected transition for a specific <s, a> pair. However, actual values can be higher or lower, so that relying on expected transitions can result in overly optimistic behavior that applies a strong set-back, from which the heat-pump is eventually not able to recover the temperature back to range by 6 pm, thus violating the comfort requirements. To hedge against that, each prediction is augmented with a dynamic safety buffer that encourages risk-taking in safer situations and discourages risk-taking in less safe situations. Specifically, each prediction is augmented as follows. Let σ be the standard deviation of the regression model measured on the training-set. Let Tᵢₙ′ be the expected temperature predicted by the regression model. Let Δₜₑₘₚ be the difference between the current temperature and the required temperature range at 6 pm, and Δₜᵢₘₑ be the number of minutes until 6 pm. Then simulate( ) uses an augmented prediction p defined as:

$$p = \{ \begin{matrix}{T}_{in}^{′} - c \cdot \frac{{Δ}_{temp}}{{Δ}_{time}} \cdot σ & if currentTemperature < 69 \\ {T}_{in}^{′} + c \cdot \frac{{Δ}_{temp}}{{Δ}_{time}} \cdot σ & if currentTemperature > 75\end{matrix}$$

where c is a constant and where Δₜₑₘₚ and Δₜᵢₘₑ are normalized by dividing Δₜₑₘₚ by 15 (° F.) and Δₜᵢₘₑ by 11≠60=660 (minutes), and trimming their quotient to a [0, 1] range. The constant c determines the maximum number of standard deviations that could possibly augment a prediction, and was determined to be 1, by running a grid search to find the best performing parameter, over a 2,500 ft² house using NYC weather data. The importance of using this dynamic safety buffer is demonstrated in the ablation analysis discussed further below. It is noted that the principles of the present invention are not to be limited in scope to the values of the constants discussed above, but are used for illustrative purposes.

In one embodiment, testing the agent's performance is started in a range of different house sizes and weathers, and continues with the ablation analysis, analyzing the contributions of the different agent components to the overall performance.

In one embodiment, to test the agent's performance, GridLAB-D was used to simulate different homes at different weather conditions over a 1-year period, where heat-pump HVAC system 101 is controlled by the agent (or application 304) of control unit 104. More specifically, 21 typical residential homes, of sizes ranging from 1,000 square feet (ft²) to 4,000 ft², were simulated. These homes were simulated under different weather conditions using typical weather data that was recorded in different cities in the United States by the U.S. National Renewable Energy Laboratory, given in a TMY2 format. The comfort requirements are as described earlier, requiring an indoor temperature of 69-75° F. from 6 pm to 7 am, with a don't-care period of 7 am-6 pm. In one embodiment, a comparison is made between the strategy of the present invention with the default thermostat strategy that is used in real deployments, where the thermostat is always on (recall that setting the thermostat back during the don't-care period when using the default strategy actually increases energy consumption).

FIGS. 9A-9D illustrate the energy savings using the agent of the present invention in 21 different house sizes using typical weather conditions recorded in New York City, Boston and Chicago when including and excluding the three exploration days in accordance with an embodiment of the present invention. As illustrated in FIGS. 9A-9D, FIGS. 9A-9D show the energy saved by the agent of the present invention with respect to the default thermostat strategy, both as a percentage, and in actual savings. Energy savings are shown both when including the exploration period (days 1-365) and when excluding it (days 4-365). Excluding it is reasonable to do given that the increased consumption during days 1-3 is a one-time cost, while the savings starting day 4 could continue for several years. It is seen that even when including the exploration period, the agent of the present invention still saves 628-1,327 kWh over the course of a year, or 5.7%-12.4%, depending on the house size and weather conditions. When excluding the exploration period the savings are 734-1,572 kWh, or about 7.0%-14.5% per year. FIG. 10 is a histogram 1000 showing how the agent of the present invention minimizes violations of the temperature comfort requirements (69-75° F., vertical lines 1001, 1002) in accordance with an embodiment of the present invention. As illustrated in FIG. 10, histogram 1000 shows the temperatures at the end of the don't care period, namely, 6 pm, in more than 22,000 simulated days, using 21 different house sizes, using weather conditions recorded at the cities from FIGS. 9A-9D.

FIGS. 11A-11D illustrate how the agent of the present invention controls the temperature in mild and extreme winter/summer days in accordance with an embodiment of the present invention. In particular, FIGS. 11A-11D illustrate how the agent of the present invention controls the temperature of a house in the New York City area in mild and hot summer days (top-left and top-right, respectively) and mild and cold winter days (bottom-left and bottom-right, respectively). The x-axis is the time of day and the y-axis is the temperature, where the don't care period is between the two vertical lines and the desired temperature range is between lines 1101, 1102. It is noted that in the top-left, the agent of the present invention waits until the temperature drops back instead of starting to cool earlier.

FIG. 12 is a table (Table 1) that shows an ablation analysis that tests the contribution of each of the agent's main components to its overall performance in accordance with an embodiment of the present invention. All simulations are done on a single, typical 2,500 ft² home using weather files recorded at New York City. Performance is summarized with respect to both energy consumption and satisfying comfort requirements. The “Comfort Violations” column displays the number of days in which the temperature was outside 69-75° F. by 6 pm, and the “Range of 6 pm Temp.” column displays the range of temperatures measured at 6 pm throughout the year. The bottom line of the table summarizes the final agent's performance. The upper part of the table summarizes the performance of the agent when one or more components are removed. Components are named as follows: ‘prevAct’ is the previous-action regression feature used by LearnHouseModel; ‘hist’ is the history of ten indoor temperatures that are used by LearnHouseModel; ‘conf’ is the dynamic confidence bound, or safety buffer, used inside TreeSearch. It is seen that removing each of these components by itself does not significantly increase the energy consumption, but removing ‘conf’ and ‘hist’ does result in a slightly reduced comfort. When removing the ‘prevAct’ and ‘hist’ together, energy consumption increases by 5.4% and comfort is violated more significantly due to the prediction errors in the transition function resulting from the absence of these features which are correlated with the hidden state of the house. When removing all three features altogether, energy consumption increases by 9.5%, and comfort violations increase to a level in which the agent misses the specification by up to 10° F. The bottom part of the table shows how performance deteriorates (increase in energy consumption) when changing the dynamic safety buffer's constant to a value of 2, or making the buffer a fixed value of 2 standard deviations.

Heat-pump systems are gaining increased popularity as a part of the effort to move society to sustainable energy consumption. While setting back the temperature is an effective energy saving strategy in other HVAC systems, the common practice is to avoid setting back heat-pump systems as when used with existing control strategies it actually increases energy consumption. As discussed herein, the principles of the present invention involve designing and implementing a complete reinforcement learning agent that learns an effective set-back strategy, which lead to roughly 7.0%-14.5% of yearly energy savings in a realistic simulation of different house sizes and weather conditions. The agent of the present invention is adaptive in the sense that when it is deployed in a new house, it learns the house properties and efficiently plans and executes a set-back strategy, which both saves energy starting the fourth day, and minimizes violations of the temperature comfort constraints.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for efficiently utilizing an HVAC system, the method comprising:
selecting each of a plurality of possible actions over a first period of time;
recording effects of selecting actions in terms of a data set of tuples during said first period of time;
selecting a model to fit a regression using regression features during a second period of time, wherein said regression features comprise a current indoor temperature, a current outdoor temperature and a plurality of historic indoor temperatures;
fitting said regression to model a transition function for each of said plurality of possible actions using said data set of tuples during said second period of time;
determining, by a processor, an action to take using a lookahead planning approach of said selected model during said second period of time for every time-step within each sub-period of said second period of time until an end of said sub-period of said second period of time, wherein said time-step corresponds to a fixed segment of time within said second period of time, wherein said action corresponds to implementing one of said plurality of possible actions; and
recording effects of selecting actions in terms of said data set of tuples during said second period of time.

2. The method as recited in claim 1, wherein said sub-period of said second period of time occurs during a time an occupant of a residence, office or building does not care about a temperature inside said residence, office or building.

3. The method as recited in claim 1, wherein said first period of time corresponds to an exploratory period, wherein said second period occurs after an end of said exploratory period.

4. The method as recited in claim 1, wherein said first period of time comprises a period of time less than a week.

5. The method as recited in claim 1, wherein a temperature during said second period of time does not exceed 100 degrees Fahrenheit and is not less than 40 degrees Fahrenheit.

6. The method as recited in claim 1, wherein said plurality of possible actions comprises cooling, off, heat-pump heating and auxiliary heating.

7. The method as recited in claim 1, wherein said current outdoor temperature is predicted using a weather forecast.

8. The method as recited in claim 1, wherein said regression features further comprise energy consumed by an action previously taken.

9. The method as recited in claim 1, wherein said data set of tuples comprises a data set of actions, states and transition states.

10. A computer program product for efficiently utilizing an HVAC system, the computer program product comprising a computer readable storage medium having program code embodied therewith, the program code comprising the programming instructions for:
selecting each of a plurality of possible actions over a first period of time;
recording effects of selecting actions in terms of a data set of tuples during said first period of time;
selecting a model to fit a regression using regression features during a second period of time, wherein said regression features comprise a current indoor temperature, a current outdoor temperature and a plurality of historic indoor temperatures;
fitting said regression to model a transition function for each of said plurality of possible actions using said data set of tuples during said second period of time;
determining an action to take using a lookahead planning approach of said selected model during said second period of time for every time-step within each sub-period of said second period of time until an end of said sub-period of said second period of time, wherein said time-step corresponds to a fixed segment of time within said second period of time, wherein said action corresponds to implementing one of said plurality of possible actions; and
recording effects of selecting actions in terms of said data set of tuples during said second period of time.

11. The computer program product as recited in claim 10, wherein said sub-period of said second period of time occurs during a time an occupant of a residence, office or building does not care about a temperature inside said residence, office or building.

12. The computer program product as recited in claim 10, wherein said first period of time corresponds to an exploratory period, wherein said second period occurs after an end of said exploratory period.

13. The computer program product as recited in claim 10, wherein said first period of time comprises a period of time less than a week.

14. The computer program product as recited in claim 10, wherein a temperature during said second period of time does not exceed 100 degrees Fahrenheit and is not less than 40 degrees Fahrenheit.

15. The computer program product as recited in claim 10, wherein said plurality of possible actions comprises cooling, off, heat-pump heating and auxiliary heating.

16. The computer program product as recited in claim 10, wherein said current outdoor temperature is predicted using a weather forecast.

17. The computer program product as recited in claim 10, wherein said regression features further comprise energy consumed by an action previously taken.

18. The computer program product as recited in claim 10, wherein said data set of tuples comprises a data set of actions, states and transition states.

19. A heat-pump based HVAC system, comprising:
a heat-pump for providing heat energy from a source of heat to a destination;
an auxiliary heating system for heating a residence, office or building when it is not energy effective to utilize said heat-pump; and
a control unit connected to said heat-pump and said auxiliary heating system, wherein said control unit comprises:
a memory unit for storing a computer program for controlling a utilization of said heat-pump and said auxiliary heating system; and
a processor coupled to the memory unit, wherein the processor is configured to execute the program instructions of the computer program comprising:
selecting each of a plurality of possible actions over a first period of time;
recording effects of selecting actions in terms of a data set of tuples during said first period of time;
selecting a model to fit a regression using regression features during a second period of time, wherein said regression features comprise a current indoor temperature, a current outdoor temperature and a plurality of historic indoor temperatures;
fitting said regression to model a transition function for each of said plurality of possible actions using said data set of tuples during said second period of time;
determining an action to take using a lookahead planning approach of said selected model during said second period of time for every time-step within each sub-period of said second period of time until an end of said sub-period of said second period of time, wherein said time-step corresponds to a fixed segment of time within said second period of time, wherein said action corresponds to implementing one of said plurality of possible actions; and
recording effects of selecting actions in terms of said data set of tuples during said second period of time.

20. The heat-pump based HVAC system as recited in claim 19, wherein said sub-period of said second period of time occurs during a time an occupant of a residence, office or building does not care about a temperature inside said residence, office or building.

21. The heat-pump based HVAC system as recited in claim 19, wherein said first period of time corresponds to an exploratory period, wherein said second period occurs after an end of said exploratory period.

22. The heat-pump based HVAC system as recited in claim 19, wherein said first period of time comprises a period of time less than a week.

23. The heat-pump based HVAC system as recited in claim 19, wherein a temperature during said second period of time does not exceed 100 degrees Fahrenheit and is not less than 40 degrees Fahrenheit.

24. The heat-pump based HVAC system as recited in claim 19, wherein said plurality of possible actions comprises cooling, off, heat-pump heating and auxiliary heating.

25. The heat-pump based HVAC system as recited in claim 19, wherein said current outdoor temperature is predicted using a weather forecast.

26. The heat-pump based HVAC system as recited in claim 19, wherein said regression features further comprise energy consumed by an action previously taken.

27. The heat-pump based HVAC system as recited in claim 19, wherein said data set of tuples comprises a data set of actions, states and transition states.

28. The heat-pump based HVAC system as recited in claim 19, wherein said auxiliary heating system comprises a resistive heat coil.
